(19) United States
(12) Patent Application Publication
(10) Pub. No.: US 2007/0289204 A1
(43) Pub. Date: Dec. 20, 2007

(54) Method of making wood fuel pellets and the like

(76) Inventor: Dirk Kahlen, Geldern (DE)

Correspondence Address: K.F. ROSS P.C., 5683 RIVERDALE AVENUE, SUITE 203 BOX 900, BRONX, NY, 10471-0900, US

(21) Appl. No.: 11/811,984

(22) Filed: Jun. 13, 2007

(30) Foreign Application Priority Data
Jun. 14, 2006 (DE) 102006027927.1

(51) Int. Cl. C10L 5/06; B29C 43/04

(52) U.S. Cl. 44/550; 264/517; 264/109; 264/115; 44/596

(57) ABSTRACT

A compressed wood fuel product is made by first coarsely comminuting pieces of scrap wood from a manufacturing process and/or pieces of virgin wood to produce a mixture of coarse combustible particles and coarse generally noncombustible particles. Then the noncombustible particles are separated from the coarse combustible particles. The coarse combustible particles are then comminuted into fine particles that are compressed into bodies suitable for use as fuel.

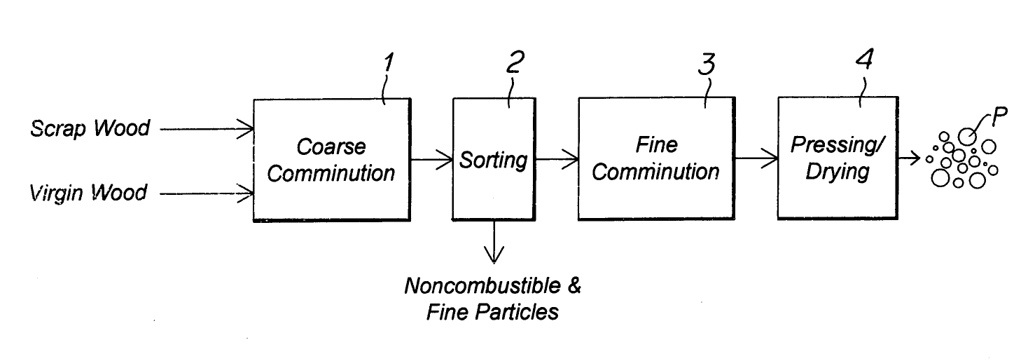

### FIELD OF THE INVENTION

The present invention relates to a method of making wood fuel pellets, brickets, and the like. More particularly this invention concerns a general method of making fuel from wood particles.

### BACKGROUND OF THE INVENTION

It is known to make wood fuel in pellet or bricket form by compressing wood particles with a binder into the desired shape and then drying the compressed products. Such a product is burned for heating purposes and constitutes an environmentally friendly heat source since it is obtained from a relatively rapidly renewable raw material.

The standard process consists in machining waste products obtained in the course of wood processing, mainly in the form of sawdust.

A primary disadvantage of this is that the amount of raw material available is limited and is dependent on the output of the wood-processing plants. Furthermore, the raw material in question is available only in the vicinity of a wood-processing plants, or else must be transported to the plant that converts it into a form usable as fuel.

### OBJECTS OF THE INVENTION

It is therefore an object of the present invention to provide an improved method of making wood fuel pellets and brickets.

Another object is the provision of such an improved method of making wood fuel pellets and brickets that overcomes the above-given disadvantages, in particular that produces a high-quality product and that is not dependent on the waste output of a wood-processing plant.

### SUMMARY OF THE INVENTION

A compressed wood fuel product is made according to the invention by first coarsely comminuting pieces of scrap wood from a manufacturing process and/or pieces of virgin wood to produce a mixture of coarse combustible particles and coarse generally noncombustible particles. Then the noncombustible particles are separated from the coarse combustible particles. The coarse combustible particles are then comminuted into fine particles that are compressed into bodies suitable for use as fuel.

Thus according to the invention at least a fraction of the fine wood particles for compression are obtained from an upstream processing operation from waste wood and/or virgin wood and then coarsely comminuted into coarse particles. Extraneous elements, typically noncombustible, are separated out, and the remaining combustible coarse particles are finely comminuted. With this system it is possible to produce standard pressed wood fuel products much more easily, since the raw material is available almost without limitation and without geographical focus.

Virgin wood refers to debranched trees, and waste wood encompasses relatively coarse wastes from wood machining and wood processing, such as scrap, offcuts, chips of solid natural wood or else of treated wood, for example. Likewise included in this term are pallets made of solid wood or of wood-based materials, and also other articles made of solid wood or wood-based materials, such as construction-grade chipboard, furniture, and also crates and boxes, for example. Most particularly usable for the production of pressed wood product are the waste wood pieces that in the German Waste Wood Ordinance (Altholzverordnung) bear the designations AI and AII.

### BRIEF DESCRIPTION OF THE DRAWING

The above and other objects, features, and advantages will become more readily apparent from the following description, reference being made to the accompanying drawing whose sole FIGURE is a diagram illustrating the method of this invention.

### SPECIFIC DESCRIPTION

Coarse comminution shown at step 1 can be accomplished, for example, by beating in a hammer mill or by a shredder, and the resultant chips may have a size of approximately 1-50 mm. The separation of extraneous elements of step 2 such as sand, earth, nails, screws, etc. can be accomplished by means of screening, for example.

In accordance with the invention at least a substantial fraction of the fine wood particles for compression, i.e. at least more than 50%, or more particularly all the fine wood particles that are pressed are provided by an upstream processing operation from waste wood and/or virgin wood, so that the majority of the fine wood particles is made from locally available waste wood and/or virgin wood, and more particularly all of the fine wood particles is obtained from such wood.

The wood products P may advantageously take the form of wood pellets or wood brickets, which are the most common forms of pressed wood product for heating purposes. However, other compressed forms are also possible, provided that they are suitable for the intended end use, namely that of burning for heating purposes.

Preferably, during or before fine comminution in step 3, the fractions which have already been comminuted to fine wood particles can be taken off and collected in a buffer or stored, thereby increasing the efficiency of the comminuting operation 3.

The separation of extraneous elements of step 2 may take place by means of mechanical methods, such as screening, for example. Other methods as well, however, are possible for the separation of extraneous elements, examples being magnetic separation methods for the separation of ferromagnetic constituents, or else gravimetric separation, in a stream of air, for example.

In one preferred exemplary embodiment it is possible—depending on the fraction of extraneous, non-wood substances in the fine wood particles—to mix fine wood particles which have been prepared in step 1 from scrap wood and/or virgin wood, but is contaminated, with a less impure, i.e. less contaminated, fine wood particles, more particularly totally pure fine wood particles, thereby allowing the use of fine wood particles even from contaminated wood to produce the pressed wood product. In this case the fine wood particles for compression, which are a mixture of contaminated and uncontaminated fine wood particles, is able to meet the limits set by DIN 51731, particularly with regard to the contaminants present, and is able to have a corresponding composition.

The invention also relates to a pressed wood produce that has been compressed from fine wood particles. The existing pressed wood product and the disadvantages they occasion have already been referred to in the introduction.

This object of specifying a pressed wood produce that can be produced without regard to the local availability of sawdust is achieved by virtue of at least a fraction of the compressed fine wood particles being composed of waste wood and/or virgin wood obtained from an upstream processing operation by coarse comminution, separation of extraneous elements and fine comminution to fine wood particles. This provides a generic wood compact which is significantly easier to produce, since the “raw material” is available almost without limitation and without geographical focus.

The wood compact may preferably take the form of a wood pellet or wood bricket, which are the most common forms of pressed wood product for heating purposes. Also possible, however, are other compressed forms, provided that they are suitable for the intended end use, namely burning for heating purposes.

I claim:

1. A method of making a compressed wood fuel product, the method comprising the steps of:
a) coarsely comminuting pieces of scrap wood from a manufacturing process or pieces of virgin wood to produce a mixture of coarse combustible particles and coarse noncombustible particles;
b) separating the noncombustible particles from the coarse combustible particles;
c) finely comminuting the coarse combustible particles into fine particles; and
d) compressing the fine particles into bodies suitable for use as fuel.

2. The method defined in claim 1 wherein the fine comminution of step c) uses generally only the coarse combustible particles produced by step a).

3. The method defined in claim 1 wherein the bodies are pellets or brickets.

4. The method defined in claim 1, further comprising after step a) and prior to step c), the step of
b′) separating out and storing any fine-particle fraction from the coarse particles.

5. The method defined in claim 1 wherein step b) is effected mechanically.

6. The method defined in claim 1 wherein step b) is effected by screening.

7. The method defined in claim 1 further comprising the steps of:
c′) ascertaining a percentage of nonwood particles in the fine particles produced by step c), and
c″) adding to the fine particles a quantity of pure-wood particles in accordance with the ascertained percentage.

8. A wood-fuel product produced by the method of claim 1.

9. The product defined in claim 8 wherein the objects are pellets or brickets.
